(19) United States
(12) Patent Application Publication
(10) Pub. No.: US 2008/0082832 A1
(43) Pub. Date: Apr. 3, 2008

(54) Configurable Data Access Application For Highly Secure Systems

(76) Inventors: Monty D. McDougal, Plano, TX (US); William E. Sterns, Wylie, TX (US); Jason E. Ostermann, Plano, TX (US)

Correspondence Address: BAKER BOTTS LLP, 2001 ROSS AVENUE, 6TH FLOOR, DALLAS, TX, 75201-2980, US

(21) Appl. No.: 11/537,383

(22) Filed: Sep. 29, 2006

(51) Int. Cl. H04L 9/32; H04L 9/00; G06K 9/00; H04K 1/00; G06F 17/30; G06F 7/04

(52) U.S. Cl. 713/183; 726/2

(57) ABSTRACT

In a method embodiment, a method for providing access to data includes intercepting a user request for access to data. In response to intercepting the user request, the method includes validating the user request by: authenticating an identification of the user; authenticating a password of the user; storing a first session identification locally; storing a second session identification in a system database; validating that the first session identification is consistent with the second session identification; and performing the user request upon successful completion of the validation process.

### TECHNICAL FIELD

This invention relates in general to the field of information technology and, in particular, to managing data accessibility within classified information systems.

### BACKGROUND

Most modern classified information systems include some form of security. However, in many instances the management of data accessibility is not flexible enough to meet the stringent and varying requirements of the Director of Central Intelligence Directives with sufficient efficiency.

### SUMMARY OF THE EXAMPLE EMBODIMENTS

In a method embodiment, a method for providing access to data includes intercepting a user request for access to data. In response to intercepting the user request, the method includes validating the user request by: authenticating an identification of the user; authenticating a password of the user; storing a first session identification locally; storing a second session identification in a system database; validating that the first session identification is consistent with the second session identification; and performing the user request upon successful completion of the validation process.

Technical advantages of some embodiments of the invention may include providing web-based data access management, including password, session, and user management capability. Various embodiments may be specifically designed to meet the requirements of the Director of Central Intelligence Directives (“DCID”). Some embodiments may be capable of terminating or “killing” active sessions of logged in users.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1A is a block diagram illustrating one embodiment of a system having a data access application;

FIG. 1B is a block diagram illustrating one embodiment of certain modules of the data access application of FIG. 1A;

FIGS. 2A and 2B is a flowchart illustrating acts related to logging in performed by one embodiment of certain modules of the data access application of FIG. 1B;

FIG. 3 is a flowchart illustrating acts related to session management performed by one embodiment of certain modules of the data access application of FIG. 1B; and

FIG. 4 illustrates an embodiment of a graphical user interface (GUI) that may be used with the data access application of FIG. 1B.

### DESCRIPTION OF EXAMPLE EMBODIMENTS

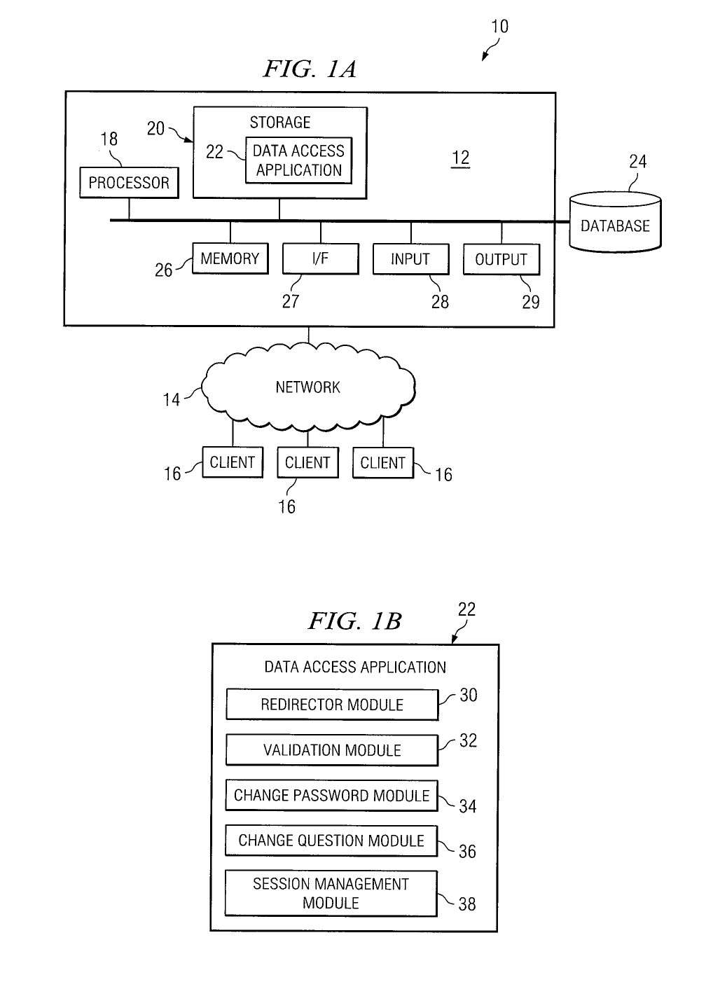

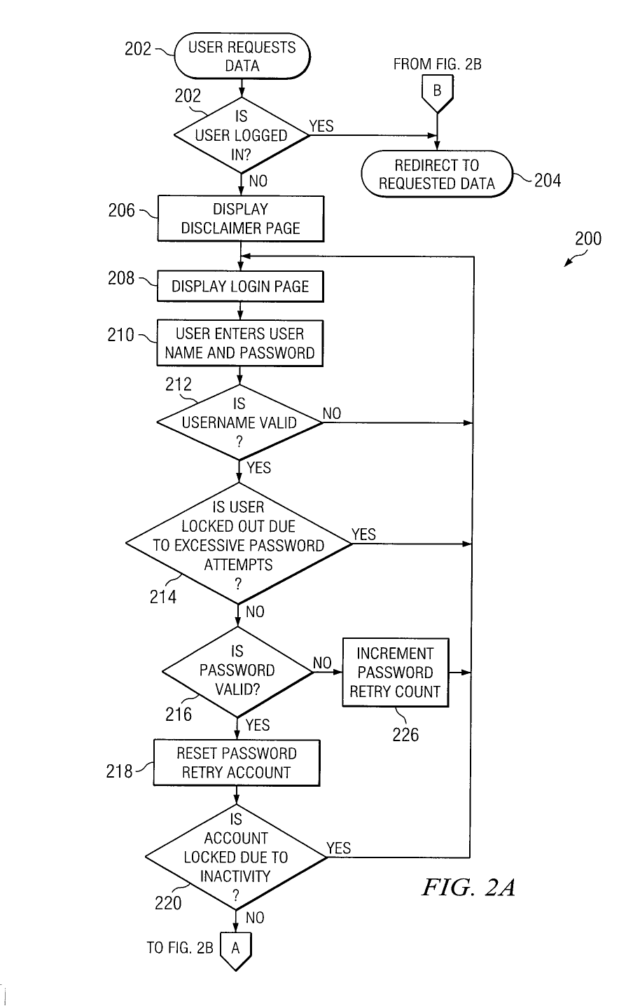

In accordance with the teachings of the present invention, a method and system for providing access to data are provided. Embodiments of the present invention and its advantages are best understood by referring to FIGS. 1A through 4 of the drawings, like numerals being used for like and corresponding parts of the various drawings. Particular examples specified throughout this document are intended for example purposes only, and are not intended to limit the scope of the present disclosure.

FIG. 1A is a block diagram of one embodiment of a system 10 that generally includes a plurality of clients 16 connected to a server 12 through a network 14. As discussed further below, a data access application 22, residing in storage 20 on server 24, generally provides data access management for system 10.

Client 16 generally refers to any suitable device operable to communicate with server 12 through network 14. Client 16 may execute with any of the well-known MS-DOS, PC-DOS, OS-2, MAC-OS, WINDOWS™, UNIX, or other appropriate operating systems, including future operating systems. Client 16 may include, for example, a personal digital assistant, a computer such as a laptop, a cellular telephone, a mobile handset, or any other device operable to communicate with server 12 through network 14.

Network 14 may refer to any interconnecting system capable of transmitting audio, video, signals, data, messages, or any combination of the preceding. Network 14 may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding. In particular embodiments of the invention, network 14 may transmit information in packet flows; however, information may alternatively be transferred without the use of packets. A packet flow includes one or more packets sent from a source to a destination. A packet may comprise a bundle of data organized in a specific way for transmission, and a frame may comprise the payload of one or more packets organized in a specific way for transmission. A packet-based communication protocol such as Internet Protocol (IP) may be used to communicate the packet flows.

Server 12 may include, for example, a file server, a domain name server, a proxy server, a web server, a computer workstation, or any other device operable to respond to requests for data from clients 16. Server 12 may execute with any of the well-known MS-DOS, PC-DOS, OS-2, MAC-OS, WINDOWS™, UNIX, or other appropriate operating systems, including future operating systems. In the illustrated embodiment, server 12 comprises one or more Apache Jakarta Tomcat web servers, which typically may run on either WINDOWS or UNIX platforms. Server 12 typically includes a processor 18, memory 26, an interface 27, input functionality 28, and output functionality 29, described in greater detail below; however, server 12 may be any appropriate server type.

Database 24 stores data, and facilitates addition, modification, and retrieval of such data. In various embodiments, Database 24 may be used to conveniently consolidate all configuration settings associated with data access application 22. In the illustrated embodiment, database 24 utilizes a relational database management system to store data, making data available and accessible through an easy to use, well understood access language, such as Structured Query Language (“SQL”). This provides database 24 with ease of data access, a high degree of reliability, availability, scalability, good performance and cluster support. In other embodiments, database 24 may utilize other data management systems. For example, in other embodiments database 24 may include an LDAP server. In the illustrated embodiment, database 24 resides separate from server 12. For example, database 24 may be stored on a separate dedicated server. In other embodiments database 24 may reside within server 12.

As explained in detail below, in operation of this particular embodiment, a user may access data of system 10 by first logging in using a client node 16 operable to communicate with server 12 through network 14. Once the user has authenticated, data access application 22 residing in storage 20 of server 12 may continue to manage the user session, including, for example, data accessibility each time the user requests data. In addition, managing the user session may include the capability to terminate the user session, even after the user has authenticated.

Most conventional data access applications are not flexible enough to efficiently comply with the stringent and varying requirements of the Director of Central Intelligence Directives (e.g., “DCID 6/3”) or other security regulations or requirements. Conventional data access applications that may meet DCID 6/3 requirements are often limited for a variety of reasons. For example, many data access applications designed for classified systems include an application programming interface (“API”) that is typically written for a specific server archetype and setup, and which often must be rewritten for alternative or upgraded archetypes and/or setups. In addition, the typical functional reliance of many conventional data access applications on the host server often precludes the use of a separate device to store client data and all configuration settings, such as a separate relational database. Accordingly, in some particular embodiments of the present invention, data access application 22 provides more modular and flexible data access management for system 10 that may be efficiently configured and updated. Basic functionality of data access application 22 and several example modules are described further in relation with FIG. 1B.

FIG. 1B is a block diagram illustrating several example modules of the data access application 22 of FIG. 1A. In general, data access application 22 is capable of managing logins, passwords, accounts, sessions, users, and groups. In this particular embodiment, data access application 22 meets DCID 6/3 requirements for managing data accessibility. Various embodiments may comprise a middleware layer to abstract requests for data from a back-end or server-side data source, such as relational database 24.

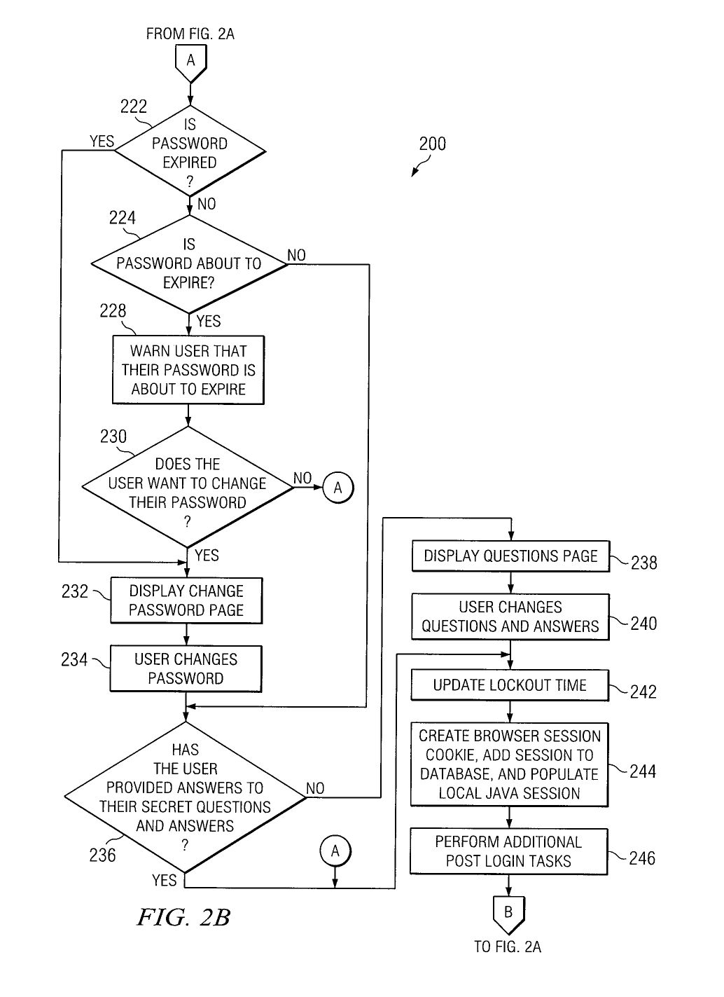

In particular embodiments, data access application 22 may comprise one or more flexible web-based modules 30, 32, 34, and 36 that may be customized to particular needs. Such web-based modules 30, 32, 34, and 36 may include, for example, JAVA programming language for enhanced web functionality. JAVA provides cross-platform compatibility, system stability, and is generally well documented; however, any suitable programming language may be used without departing from the scope of the present disclosure. In this particular embodiment, the web-based modules include a redirector module 30, a validation module 32, a change password module 34, a change question module 36, and a session management module 38. Flowcharts and a graphical user interface of associated with these generalized example modules 30, 32, 34, 36, and 38 are illustrated in FIGS. 2A through 4.

As shown in FIGS. 2A and 2B, flowchart 200 illustrates example acts performed by web-based redirector module 30, validation module 32, change password module 34, change question module 36, and session management module 38 for the data access application 22 of FIG. 1B. Although modules 30, 32, 34, 36 and 38 are web-based, other types of modules may use the teachings of the present disclosure without departing from the scope of the present invention.

Flowchart 200 begins in block 202 when a user requests data. Redirector module 30 is generally capable of intercepting the user request for data and redirecting the request through validation module 32. At block 202, a determination is made of whether the user is actively logged in, as explained further below. If the user is actively logged in, redirector module 30 directs the user to the requested data in block 204. However, if the user is not actively logged in, redirector module 30 displays a disclaimer page in block 206. Once the user acknowledges acceptance of the disclaimer page terms, redirector module 30 displays a login page in block 208. The user then enters a username and password in block 210, which is validated by validation module 32.

Blocks 212 through 236 of validation module 32 generally include a series of determinations regarding the username and password entries of block 210 and general account management. Determinations are made of whether the username is valid and whether the user is locked out due to excessive password attempts in blocks 212 and 214 respectively. If the username is invalid or if the user is locked out due to excessive password attempts, the module loops back to the display login page of block 208. However, if the username is valid and the user is not locked out due to excessive password attempts, a determination is made of whether the password is valid in block 216. In various embodiments, the password may be invalid due to an administrative lockout in which an account expiration date is specified by an administrator. For example, an administrator may create an account with a username and password that will expire if the username and password are not changed within three days of creating the account. If the password is invalid, a password retry count is incremented in block 226 and the module loops back to the display login page of block 208. However, if the password is valid validation module 32 resets the password retry count in block 218 and then determines whether the account is locked due to inactivity in block 220. If the account is locked due to inactivity, validation module 32 loops back to the display login page of block 208. Otherwise, validation module 32 determines whether the password is now expired in block 222. If the password is expired, validation module 32 displays a change password page in block 232. However, if the password has not expired, validation module 32 determines whether the password is about to expire in block 224. If the password is about to expire, validation module warns the user in block 229 and then determines whether the user wants to change the password in block 230. If the user wants to change the password, validation module redirects to a change password module 34 that displays the password change page of block 232. The user then changes the password in block 234. In various embodiments, change password module 34 may only accept “strong” passwords, such as, for example, passwords that are DCID 6/3 compliant.

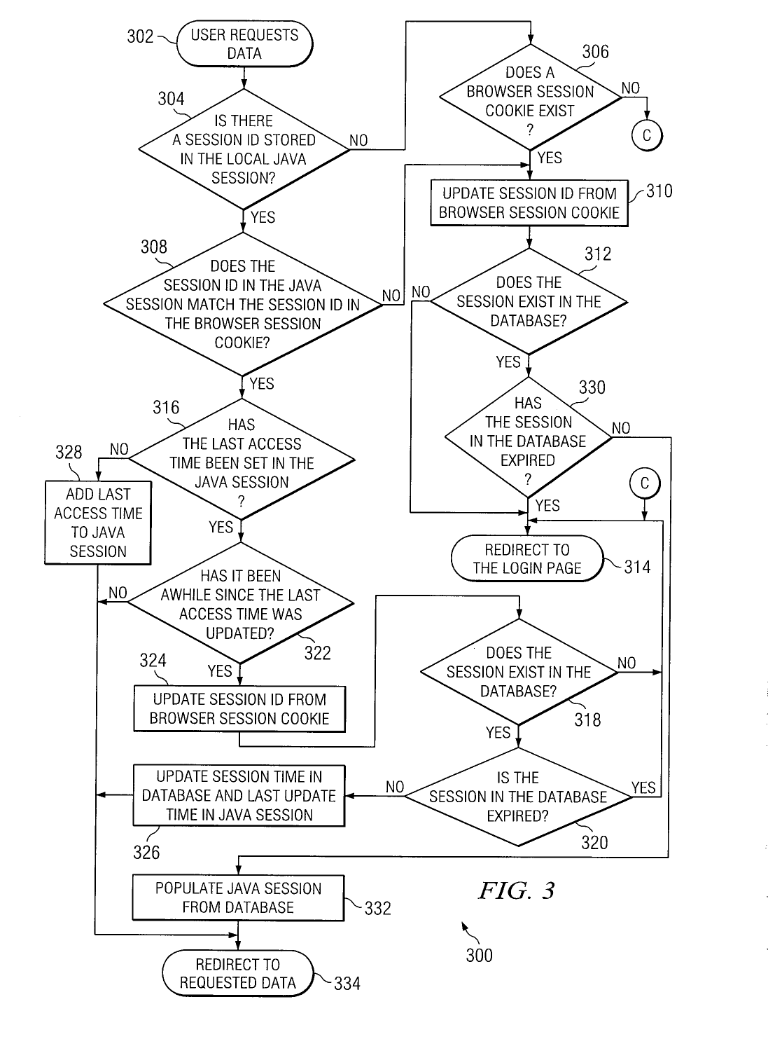

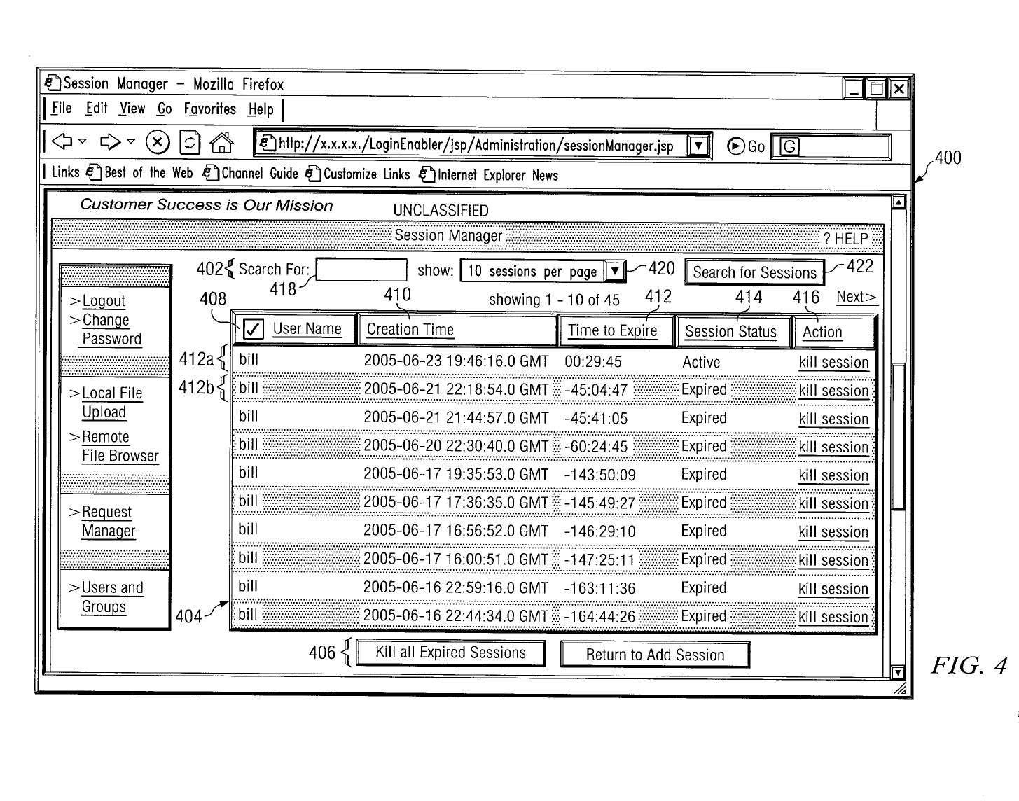

If the password is not about to expire, or if the user has successfully changed the password, then a determination is made of whether the user has provided answers to the secret questions and answers in block 236. If the user has not provided answers to the secret questions, then change question module 36 displays a question page in block 238 and the user selects questions and provides answers in block 240. Once the user selects questions and provides the answers, or if the user had already done so previously, validation module 32 updates the lockout time in block 242. Then validation module 32 creates a local browser session cookie (e.g., on client 16), stores a session identification in the database 24, and populates a local JAVA session in block 244. Validation module 32 may perform additional post login tasks in block 246. Redirector module 30 then redirects the user to the requested data and terminates in block 204. Various embodiments may use the browser session cookie and session identification created in block 244 for session management purposes. For example, various embodiments may terminate active sessions by deleting the session identification stored in a server-side database. A flowchart and a graphical user interface of this generalized example of session management are illustrated in FIGS. 3 and 4 respectively.

As shown in FIG. 3, flowchart 300 illustrates example acts performed by redirector module 30 for the data access application 22 of FIG. 1B. As will be shown, web-based session management module 38 may interact with redirector module 30 session management module 38 to manage active sessions, including terminating active sessions of logged in users. Although redirector module 30 and session management module 38 are web-based, other types of modules may use the teachings of the present disclosure without departing from the scope of the present invention.

Flowchart 300 begins in block 302 when a user requests data. A determination is made of whether a session identification is stored in the local JAVA session in block 304. If a session identification is stored, a determination is made of whether the session identification stored in the local JAVA session is consistent with the local browser session cookie in block 308. If inconsistent, then the session identification stored in the local JAVA session is updated to be consistent with the browser session cookie in block 310.

Referring again to block 304, if a session identification is not stored in the local JAVA session, a determination is made of whether a browser session cookie exists in block 306. If a browser session cookie does not exist, the user is redirected to the login page in block 314. However, if a browser session cookie exists, the session identification stored in the local JAVA session is updated to be consistent with the browser session cookie in block 310.

With the session identification stored in the local JAVA session updated from the session browser cookie, determinations are then made regarding the server-side database 24 in blocks 312 and 330. If the session does not exist in the database 24, or if the session has expired, the user is redirected to the login page in block 314. However, if the session exists in the database 24 and has not expired, the JAVA session is populated from the database 24 in block 332 and the user is then redirected to the requested data in block 334.

Referring again to block 308, if the session identification in the JAVA session is consistent with the session identification in the browser session cookie, a determination is made of whether the last access time has been set in the JAVA session in block 316. If the last access time has not been set, the last access time is added to the JAVA session in block 328 and the user is then redirected to the requested data in block 334. However, if the last access time has been set, a determination is made of whether it has been awhile since the last access time was updated in block 322. If a predetermined period of time has not elapsed since the last access time was updated, the user is redirected to the requested data in block 334. However, if a predetermined period of time has elapsed since the last access time was updated, then the session identification in the JAVA session is updated from the browser session cookie in block 324. Determinations are then made regarding the server-side database 24 in blocks 318 and 320. If the session does not exist in the database 24, or if the session has expired, the user is redirected to the login page in block 314. However, if the session exists in the database 24 and has not expired, then the session time in the database 24 and the last update time in the local JAVA session are both updated in block 326, and the user is redirected to the requested data in block 334.

In the example embodiment, redirector module 30 will not redirect the user to the requested data unless the session exists in the database 24 and the session has not expired, as determined in blocks 312, 318, 320 and 330. Therefore, one example method of effectively killing an active session is by performing an action that deletes the session in the database 24. In the example embodiment, session management module 38 may enable an administrator to perform the action of deleting the session from database 24, thereby killing the session. An example embodiment of a graphical user interface (GUI) facilitating this action is illustrated in FIG. 4.

As shown in FIG. 4, GUI 400 provides a Session Manager screen capable of facilitating the management of user sessions. In this particular embodiment, GUI 400 allows an administrator to interface with the data access application 22 of FIG. 1B and control the flow of data accessible to clients 16. GUI 400 generally includes search inputs 402, action buttons 406, and an information table 404.

Search inputs 402 generally allow an administrator to search for a session, or a particular subset of sessions. To search for sessions, an administrator can type a substring of a session owner or user to search for in the text field 418. The number of sessions to show per page can be selected in the drop-down select box 420. The search may then commence by clicking the search button 422. A list of matching sessions will then display in information table 404.

Information table 404 generally provides information about specific users and respective sessions. In various embodiments, information table 404 may display information regarding all users of system 10 that have successfully logged on to system 10. In this particular embodiment, information table 404 displays information regarding a subset of system 10 users having usernames as indicated in column 408. The creation time of each respective session is indicated in column 410. The remaining time before the expiration of each respective session is indicated in column 412. For example, the first session listed in information table 404 has 29 minutes and 45 seconds remaining before expiration, as indicated by reference 412a. However, the second session listed in information table 404 expired 45 hours, 4 minutes, and 47 seconds previously, as indicated by reference 412b. The status of each session is listed in column 414. In this particular example, each session is either active or expired. To illustrate further, the session management module of FIG. 3 continually updates the expiration time of a session every time a user requests data associated with application 22; if the user has not requested a page within a certain period of time, the session will be considered expired. In various embodiments, the length of time associated with session expiration may be configurable within a server-side file, database 24, or other suitable location. In addition, application 22 may be configured to “lock out” a particular user if the user does not initiate consecutive sessions within a predetermined amount of time.

One feature of data access application 22 and associated modules is that individual sessions can be terminated or “killed” by clicking on the respective “kill session” link in column 416. In this particular embodiment, if the session is active, a warning message will be displayed. Additionally, if an active session is killed, the user of that session will be forced to login again the next time that user tries to access data associated with application 22.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for providing access to data comprising:
intercepting a user request for access to data;
in response to intercepting the user request, validating the user request by:
authenticating an identification of the user;
authenticating a password of the user;
storing a first session identification locally;
storing a second session identification in a back-end database;
validating that the first session identification is consistent with the second session identification; and
performing the user request upon successful completion of the validation process.

2. The method of claim 1, and further comprising terminating access to data by deleting the second session identification.

3. The method of claim 2, wherein terminating access to data occurs after authenticating the identification and the password of the user.

4. The method of claim 1, and further comprising terminating access to data after a predetermined lapse of time between intercepting consecutive requests from the user.

5. The method of claim 1, and further comprising terminating access to data after a predetermined amount of time has lapsed between consecutive sessions of the user.

6. The method of claim 1, wherein the method is implemented by an application having one or more web-based modules.

7. The method of claim 1, and further comprising denying access to data if a password of an account is not changed within a predetermined amount of time after creation of the account.

8. A system for providing access to data comprising:
a data access application operable to:
intercept a user request for access to data;
in response to intercepting the user request, validate the user request by:
authenticating an identification of the user;
authenticating a password of the user;
storing a first session identification locally;
storing a second session identification in a back-end database; and
validating that the first session identification is consistent with the second session identification; and
perform the user request upon successful completion of the validation process.

9. The system of claim 8, wherein the data access application is further operable to terminate access to data by deleting the second session identification.

10. The system of claim 9, wherein the data access application is further operable to terminate access after authenticating the identification and the password of the user by deleting the second session identification.

11. The system of claim 8, wherein the data access application is further operable to terminate access to data after a predetermined lapse of time between intercepted consecutive user requests.

12. The system of claim 8, wherein the data access application comprises one or more web-based modules.

13. The system of claim 8, wherein the data access application is operable to deny access to data if a password of an account is not changed within a predetermined amount of time after creation of the account.

14. Logic encoded in computer readable media, the logic being operable to:
intercept a user request for access to data;
in response to intercepting the user request, validate the user request by:
authenticating an identification of the user;
authenticating a password of the user;
storing a first session identification locally;
storing a second session identification in a back-end database; and
validating that the first session identification is consistent with the second session identification; and
perform the user request upon successful completion of the validation process.

15. The logic of claim 14, wherein the logic is further operable to terminate access to data by deleting the second session identification.

16. The logic of claim 15, wherein the logic is further operable to terminate access after authenticating the identification and the password of the user by deleting the second session identification.

17. The logic of claim 14, wherein the logic is further operable to terminate access to data after a predetermined lapse of time between intercepting consecutive requests from the user.

18. The logic of claim 14, wherein the logic is further operable to terminate access to data after a predetermined amount of time has lapsed between consecutive sessions of the user.

19. The logic of claim 17, wherein the logic comprises web-based modules.

20. The logic of claim 14, wherein the logic is operable to deny access to data if a password of an account is not changed within a predetermined amount of time after creation of the account.
